(19) United States
(12) Patent Application Publication
(10) Pub. No.: US 2015/0365192 A1
(43) Pub. Date: Dec. 17, 2015

(54) METHOD OF TUNING WAVELENGTH OF TUNABLE OPTICAL NETWORK UNIT (ONU) IN TIME AND WAVELENGTH DIVISION MULTIPLEXING-PASSIVE OPTICAL NETWORK (TWDM-PON)

(71) Applicant: ELECTRONICS AND TELECOMMUNICATIONS RESEARCH INSTITUTE, Daejeon-si (KR)

(72) Inventors: Kwang Ok KIM, Jeollabuk-do (KR); Kyeong Hwan DOO, Daejeon-si (KR); Han Hyub LEE, Daejeon-si (KR); Sang Soo LEE, Daejeon-si (KR)

(21) Appl. No.: 14/740,629

(22) Filed: Jun. 16, 2015

(30) Foreign Application Priority Data
Jun. 16, 2014 (KR) 10-2014-0073147
May 26, 2015 (KR) 10-2015-0073203

(51) Int. Cl. H04J 14/02

(52) U.S. Cl. CPC H04J 14/0267; H04J 14/0227

(57) ABSTRACT

A method of tuning a wavelength of a tunable ONU in a TWDM-PON is provided. The method includes transmitting a wavelength change request message from a source OLT to request the ONU to change a wavelength thereof from a first wavelength to a second wavelength and in response to the wavelength change request message, transmitting a wavelength change response message from the ONU to the source OLT to indicate whether or not the ONU can change a wavelength thereof. The wavelength change request message is ID information for specifying an ONU that is requested to change a wavelength thereof, and the message may comprise one of the following: system ONU ID, channel ONU ID, and individual ONU ID.

### CROSS-REFERENCE TO RELATED APPLICATION(S)

This application claims priority from Korean Patent Application Nos. 10-2014-0073147, filed on Jun. 16, 2014, and 10-2015-0073203, filed on May 26, 2015, in the Korean Intellectual Property Office, the disclosures of which are incorporated herein by references in its entirety.

### BACKGROUND

1. Field

The following description relates to a time and wavelength division multiplexing-passive optical network (TWDM-PON), and more particularly, to procedures for tuning a wavelength of an optical network unit (ONU) in a TWDM-PON.

2. Description of the Related Art

As optical communication technology is advanced and the demand for the Internet service increases rapidly, fundamental research on an optical access network has been conducted since the early 2000s, and thus introduction of a broadband convergence network (which directly connects an office or a central office (CO) to subscriber equipments through an optical fiber) such as fiber to the home (FTTH) and fiber to the office (FTTO) is generalized. Herewith, research on next generation high-speed and large-capacity optical access network technology is being actively done for responding to an explosive increase in traffic due to the spread of mobile Internet protocol (IP) terminals such as smartphones or tablet computers, the commercialization of an IP television (IPTV) service, and the spread of a multimedia broadcast/streaming service over the Internet.

As a method for efficiently providing a service to more subscriber equipments with limited network resources, a time division multiplexing (TDM) technique and a wavelength division multiplexing (WDM) technique are being applied to optical access network technology. Recently, research is being conducted on a time and wavelength division multiplexing (TWDM)-passive optical network (PON) link technique in which both the TDM technique and the WDM technique are applied. A TWDM-PON link technique may satisfy a demand for expanding a network bandwidth, and may expand communication capacity and a number of subscribers, while providing ultrahigh-speed communication services to many subscribers.

FIG. 1 is a diagram illustrating a configuration of a TWDM-PON system. Referring to FIG. 1, the TWDM-PON system includes N number of optical line terminals (OLTs), an optical distribution unit (ODN), and M number of optical network units (ONUs). The N number of OLTs multiplex downstream signals and transmit a multiplexed signal to the M number of ONUs and share a wavelength division multiplexing (WDM) MUX with the M number of ONUs, which splits upstream signals from the ONUs and transmits split signals to corresponding OLTs. Accordingly, each ONU is required to receive only a downstream signal of a specific wavelength allocated to the ONU itself among wavelength-multiplexed downstream signals and transmit an upstream signal of the specific wavelength allocated thereto. Thus, each ONU includes a transceiver whose wavelength can be selected, that is, a tunable transceiver.

The TWDM-PON link technique used by the TWDM-PON system is a Next Generation optical subscriber network technique in which the existing 10 gigabit-capable PON (XG-PON)-based frame technique and a WDM technique capable of transmitting N (e.g., N is 4 or 8) number of wavelengths are combined to provide broadband services to subscribers. By utilizing the TWDM-PON link technique, it is possible to provide a downstream transmission bandwidth of 10 Gbps and an upstream transmission bandwidth of 2.5 Gbps per WDM wavelength, as well as to provide a downstream transmission bandwidth of 40 Gbps and an upstream transmission bandwidth of 10 Gbps on a link (when N is 4).

Draft ITU-T G.989.3 (standardization in progress) describes procedures for wavelength tuning of an ONU in a TWDM-PON system. More specifically, this draft describes the use of in-band Physical Layer Operation Administration and Management (PLOAM) messages for wavelength tuning of an ONU and recognition of a new wavelength, and it newly defines the PLOAM messages, such as “Tuining_Control”, “Tuning_Response”, “US_WLCH_INFO”, and “Complete_d” PLOAM messages.

The TWDM-PON system that uses the procedures for wavelength tuning of an ONU as described in the draft is able to provide the following services:
Power saving service: A TWDM-PON system is able to provide services to subscribers by operating only some usable wavelength channels when the bandwidth used is small. If necessary for this purpose, the TWDM-PON instructs ONUs to change channels thereof when they are provided with services through wavelength channels which are not operated.
Load balancing service: When a particular wavelength channel is used by many ONUs, the TWDM-PON system instructs the ONUs to change the current channel to another so that the system can provide a quality of service.
Protection switching service: When faults occur on a particular wavelength channel or on a link, the TWDM-PON system instructs ONUs which are currently using the particular wavelength channel to switch to another wavelength channel.
Multicast service: In the case where the same wavelength channel is to be allocated to multiple ONUs that require a multicast service, the TWDM-PON system instructs the entire ONUs to change the current channel to new channels or instructs some ONUs that are using different wavelength channels to change their current channels to other channels.

For the aforementioned services, only some ONUs or all ONUs that are using a particular channel may need to change their channels to other ones according to the service type and/or service operation policies. In some cases, the entire ONUs of the TWDM-PON system may need to change their channels to different channels. For example, for energy saving service, protection switching service, and multicast service, all ONUs that are using a particular channel may need to change the current channel to another. The current draft ITU-T G.989.3 is, however, based on the assumption that all ONUs perform wavelength tuning process individually, and thus it is not efficient when all ONUs that are using the same channel or the entire ONUs of the system change their channels.

### SUMMARY

The following description relates to a method of providing wavelength tuning procedures whereby all ONUs of a time and wavelength division multiplexing-passive optical network system or all ONUs that are using a particular channel can efficiently change their wavelength to another.

In one general aspect, there is provided a method of tuning a wavelength of a tunable optical network unit (ONU) in a time and wavelength division multiplexing-passive optical network (TWDM-PON), the method including: transmitting a wavelength change request message from a source optical line terminal (OLT) to request the ONU to change a wavelength thereof from a first wavelength through which the source OLT provides a service to the ONU to a second wavelength through which a target OLT provides a service; and in response to the wavelength change request message, transmitting a wavelength change response message from the ONU to the source OLT to indicate whether or not the ONU can change a wavelength thereof, wherein the wavelength change request message contains one of the following: a system ONU identification (ID), a channel ONU ID, and individual ONU ID, as identification information for specifying an ONU that is requested to change a wavelength thereof.

The wavelength change request message may be a Tuning_Control PLOAM message, the wavelength change response message may be a Tuning_Response PLOAM message, and the identification information may be contained in an ONU-ID field of the Tuning_Control PLOAM message. The Tuning_Control PLOAM message may include a target wavelength field that contains information on the second wavelength and a source wavelength field that contains information on the first wavelength. The ONU may compare its own wavelength information with wavelength information contained in the source wavelength field and, only when both information match each other, transmit the Tuning_Response PLOAM message.

The method may further include periodically transmitting a wavelength change confirm message and upstream time allocation information from the source OLT and the target OLT in response to receiving the wavelength change response message, wherein the wavelength change response message contains wavelength tuning time information of the ONU, and the source OLT and the target OLT adaptively determine a time interval at which to transmit the wavelength change confirm message and the upstream time allocation information based on the wavelength tuning time information.

The wavelength change request message may be a Tuning_Control PLOAM message and the wavelength change response message may be a Tuning_Response PLOAM message, wherein the wavelength tuning time information comprises either or both of physical media dependence (PMD) tuning class information and transmission convergence (TC)-layer tuning time information, which are contained in the Tuning_Control PLOAM message.

The PMD tuning class information may be represented by 2 bits to indicate a time taken to perform wavelength tuning of the ONU.

When the PMD tuning class information is set to “01”, the source OLT and the target OLT each may transmit both the wavelength change confirm message and the upstream time allocation information at intervals of 125 μs; when the PMD tuning class information is set to “10”, the source OLT and the target OLT each may transmit both the wavelength change confirm message and the upstream time allocation information at specific intervals, ranging from 125 μs to 2 ms; when the PMD tuning class information is set to “11”, the source OLT and the target OLT each may transmit both the wavelength change confirm message and the upstream time allocation information at specific intervals, ranging from 2 ms to 100 ms; and when the PMD tuning class information is set to “00”, the source OLT and the target OLT each may determine the interval at which to transmit both the wavelength change confirm message and the upstream time allocation information based on the TC-layer tuning time information.

The method of claim 6, wherein the TC-layer tuning time information is represented by a 2-byte value that is counted in units of 125 μs.

The method may further include receiving, at the ONU, the wavelength change confirm message and the upstream time allocation information from the target OLT, wherein the ONU detects a physical synchronization signal of the second wavelength within a physical synchronization of window (POW) having a predetermined range based on a location of a physical synchronization signal of the first wavelength.

The physical synchronization of window may have a range of 64 bits.

In another general aspect, there is provided a method of tuning a wavelength of a tunable ONU in a TWDM-PON, the method including: transmitting a wavelength change request message from a source OLT to request the ONU to change a wavelength thereof from a first wavelength through which the source OLT provides a service to the ONU to a second wavelength through which a target OLT provides a service; in response to the wavelength change request message, transmitting a wavelength change response message from the ONU to the source OLT to indicate whether or not the ONU can change a wavelength thereof; and in response to receiving the wavelength change response message, periodically transmitting a wavelength change confirm message and upstream time allocation information from the source OLT and the target OLT, wherein the wavelength change response message contains wavelength tuning time information of the ONU, and the source OLT and the target OLRT each adaptively determine their intervals at which to transmit the wavelength change confirm message and the upstream time allocation information based on the wavelength tuning time information.

Other features and aspects will be apparent from the following detailed description, the drawings, and the claims.

### BRIEF DESCRIPTION OF THE DRAWINGS

FIG. 1 is a diagram illustrating a configuration of a TWDM-PON system.

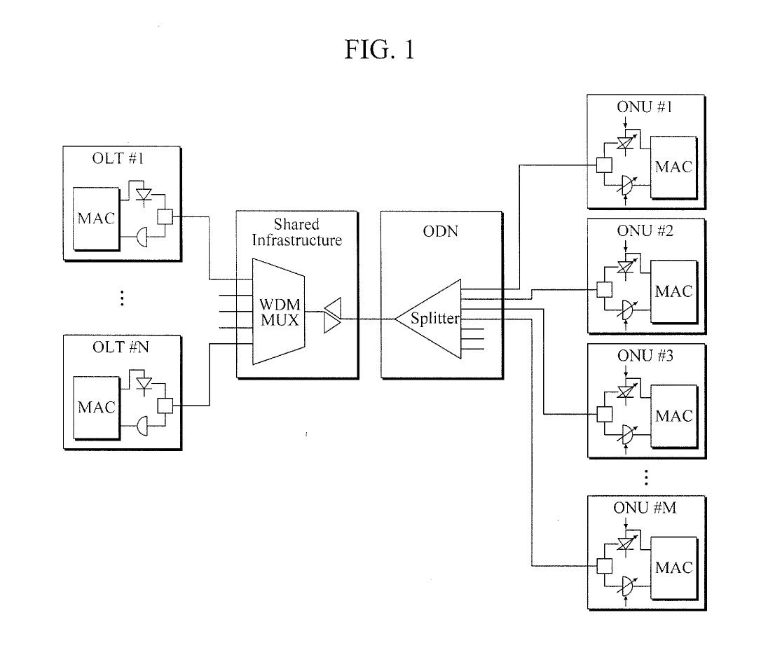

FIG. 2 is a diagram illustrating wavelength tuning process described in draft new recommendation ITU-T G.989.3.

FIG. 3 is a diagram illustrating a downstream frame synchronization (FS) frame format which is described in draft new recommendation ITU-T G.989.3.

FIG. 4 is a flowchart illustrating in detail operation S12 and operation S14 of FIG. 2 when a downstream FS frame is being used.

FIG. 5 is a table showing a configuration of Tuning_Control PLOAM message according to an exemplary embodiment.

FIG. 6 is a diagram illustrating an example of a downstream FS frame format according to an exemplary embodiment.

FIG. 7 is a table showing a configuration of a Tuning_Response PLOAM message according to an exemplary embodiment.

FIG. 8 is a flowchart illustrating in detail operations of an OLT to send PLOAMu grant information and a Tuning_Control(Confirm) PLOAM message according to the exemplary embodiment.

FIG. 9 is a graph explaining physical synchronization (Psync) restoration process that is applicable to the wavelength tuning process according to the exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

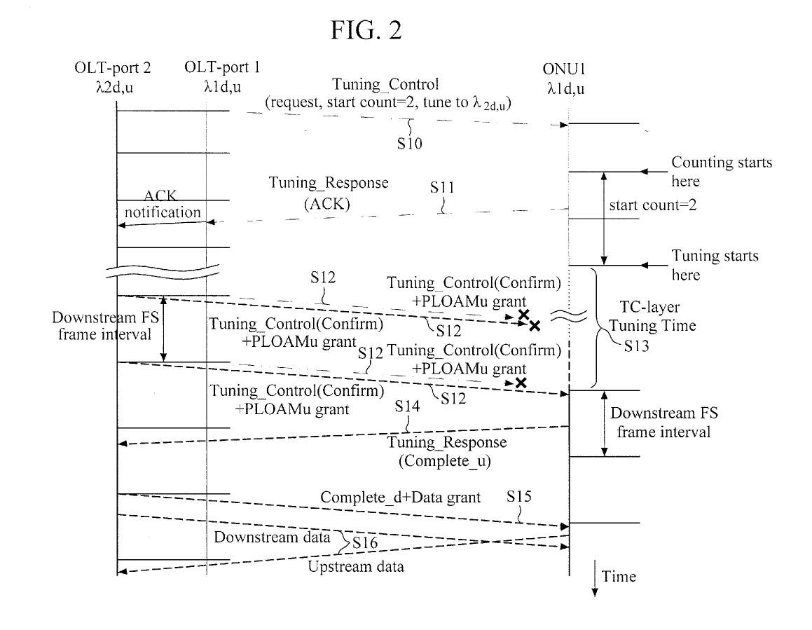

FIG. 2 is a diagram illustrating wavelength tuning process described in draft new recommendation ITU-T G.989.3 (for Consent, 4 Apr. 2014) that ITU-T Study Group 15 is working on. FIG. 2 illustrates the wavelength tuning process being performed when optical network unit (ONU)1 changes a wavelength from λ.1d,u to λ2d,u where a first optical line terminal (OLT) or OLT-port1 provides a service through the wavelength Δ1d,u and a second OLT or OLT-port2 provides a service through the wavelength λ2d,u.

Referring to FIG. 2, the OLT-port1 that provides a service using a first wavelength λ1d,u transmits a message, i.e., a Tuning_Control(Request) PLOAM message to request the ONU1 to tune a wavelength to the second wavelength 22d,u through which the OLT-port 2 provides a service as depicted in S10. At this time, the request message contains information (start count=2 in FIG. 2) about a tuning start time point and information (λ2d,u in FIG. 2) for identification of a destination wavelength, such as wavelength number. In addition, ONU-ID contained in the Tuning_Control(Request) PLOAM message specifies a particular ONU to which the message is directed.

In response to receiving the request message from the OLT-port1, the ONU1 sends to the OLT-port1 an response message, i.e., a Tuning_Response(ACK or NACK)PLOAM message that indicates whether or not the ONU1 can change a wavelength thereof in S11. The ONU1 sends a Tuning_Response(ACK) PLOAM message to the OLT-port1 when the ONU1 can change a wavelength thereof to a particular wavelength, and otherwise, sends a Tuning_Response(NACK)PLOAM message. FIG. 2 illustrates the former case. In response to receiving the response message from the ONU1, the OLT-port1 sends ACK notification to the OLT-port2 to inform the OLT-port2 of the reception of the response message.

Then, in S12, the OLT-port1 and the OLT-port2 each transmit a wavelength change confirm message, e.g., a Tuning_Control(Confirm) PLOAM message, to confirm whether the ONU has completed wavelength tuning process, as well as upstream time allocation information, e.g., PLOAMu grant information, which is information about time allocated for ONU's response, at particular time intervals (in FIG. 2, downstream FS (Frame Synchronization) frame interval of 125 μs), starting at a wavelength tuning start time point (in FIG. 2, the point shown as “tuning starts here”). After sending the Tuning_Response(ACK)PLOAM message as depicted in S11, the ONU1 performs tuning of a transmission convergence (TC) layer, starting at the wavelength tuning start time point, as depicted in S13. The TC-layer tuning comprises wavelength tuning of an optical module to a destination wavelength (i.e., physical media dependence (PMD) tuning), downstream channel synchronization, i.e., synchronization restoration on a physical layer. For the wavelength tuning of an optical module, the OLT-port1 and the OLT-port2 continuously allocate a PLOAMu grant time to the ONU1 at an interval of 125 μs. Then, when the wavelength tuning of the optical module of the ONU1 has been completed, the ONU1 detects again 64-bit physical synchronization (Psync) information to achieve downstream channel synchronization.

The ONU1 that has completed downstream channel synchronization recognizes the Tuning_Control(Confirm) PLOAM message and PLOAMu grant time which are sent from the OLT-port2, and responds to the OLT-port2 by sending a Tuning_Response(Complete_u) PLOAM message as depicted in S14. In response to the Tuning_Response(Complete_u) PLOAM message from the ONU1, the OLT-port2 stops sending both the Tuning_Control(Confirm) PLOAM message and PLOAMu grant time information, and sends a Completed_PLOAM message to the ONU1 in S15. Then, once the ONU1 receives the Completed_PLOAM message from the OLT-port2, the wavelength tuning of the ONU1 is completed, and thereafter, the ONU1 is able to be provided with services (transmission and reception of downstream data and upstream data) through the OLT-port2 as depicted in S16.

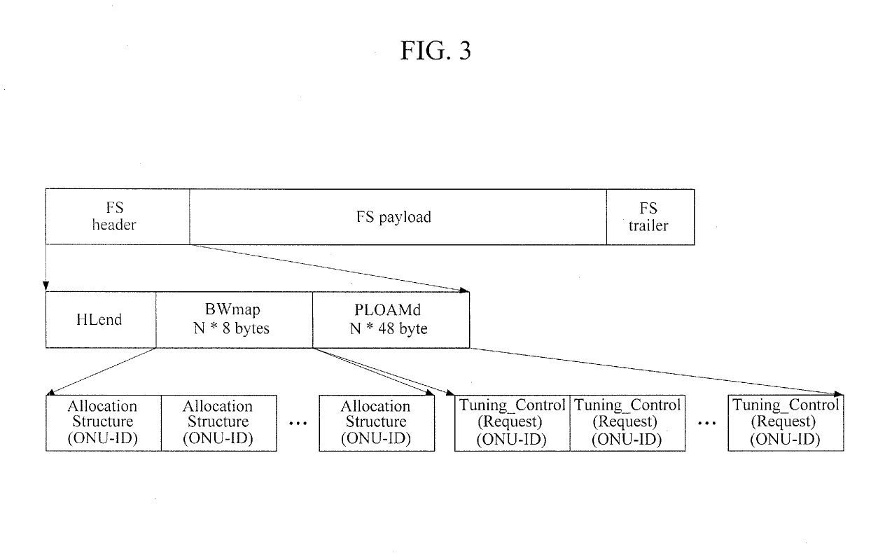

FIG. 3 is a diagram illustrating a downstream frame synchronization (FS) frame format which is described in draft new recommendation ITU-T G.989.3. Referring to FIG. 3, the downstream FS frame consists of an FS header, an FS payload, and an FS trailer. The FS header consists of HLend structure of a fixed size and two partitions of variable sizes, i.e., a bandwidth map (“BWmap”) field and a downstream PLOAM (“PLOAMd”) field. That is, the BWmap field and the PLOAMd field each include N number of allocation structures (where N is an integer that is 1 or greater) and N number of Tuning_Control (Request) PLOAM messages, wherein the sum of the allocation structures and the Tuning_Control (Request) PLOAM messages does not exceed the maximum size of the downstream FS frame.

In the case of requesting a plurality of ONUs for wavelength tuning, an OLT (OLT-port1 in FIG. 2) may add as many allocation structures and Tuning_Control(Request) PLOAM messages respectively to the BWmap field and the PLOAMd field in the downstream FS frame format as the number of the requested ONUS. In addition, the allocation structures and the Tuning_Control(Request) PLOAM messages may each include an ONU-ID that is information specifying an ONU that is a target of the downstream FS frame. That is, the Tuning_Control(Request) PLOAM message as depicted in S10 in FIG. 2 is directed to ONU1 which is identified by ONU-ID. As such, for requesting a plurality of ONUs, e.g., 256 ONUs, for wavelength tuning by using ONU-ID to identify whether each ONU is a service target, allocation structure information of 8 bytes needs to be specified for each ONU and a total of 256 48-byte PLOAMd messages need to be included in the downstream FS frame, wherein the 8-byte allocation structure information is time-allocation information used for receiving a Tuning_Response(ACK, NACK) PLOAM message and the PLOAMd messages are used to transmit Tuning_Control(Request) PLOAM messages. That is, to request 256 ONUs for wavelength tuning, FS header uses 14,436 bytes, which may affect data transmission in a continuous downstream mode.

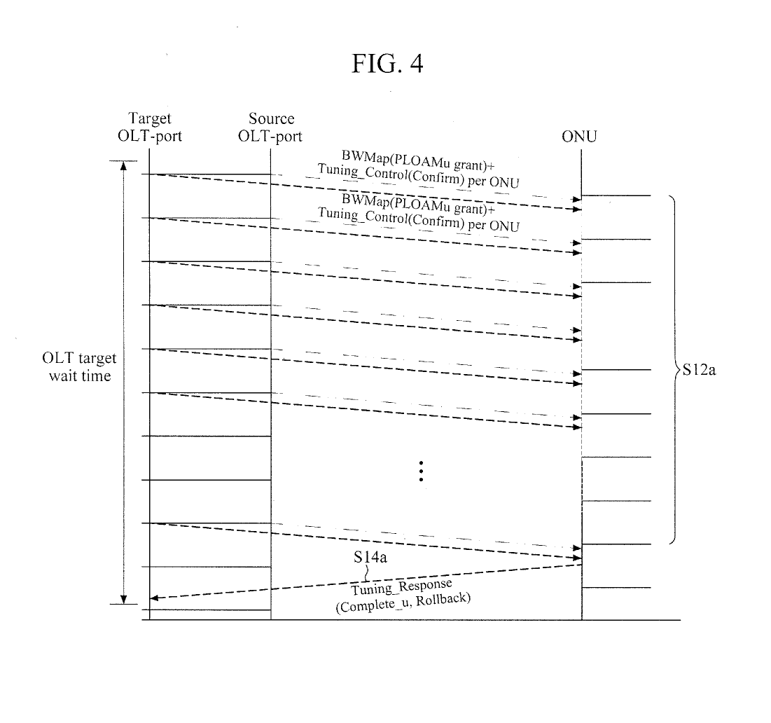

FIG. 4 is a flowchart illustrating in detail operation S12 and operation S14 of FIG. 2 when a downstream FS frame is being used. Referring to FIG. 4, operations of periodically transmitting PLOAMu grant information and Tuning_Control(Confirm) PLOAM messages to confirm whether an ONU has completed wavelength tuning process are illustrated in detail, wherein the PLOAMu grant information relates to a time that is allocated for an ONU's response. In FIG. 4, source OLT-port indicates an OLT, which provides a service prior to wavelength tuning like OLT-port1 of FIG. 2, and target OLT-port indicates an OLT which provides a service after wavelength tuning like OLT-port2 of FIG. 2.

Referring to FIG. 4, in S12a, the source OLT-port and the target OLT-port each repeatedly transmit PLOAMu grant information and Tuning_Control(Confirm) PLOAM message at intervals of 125 μS until TC-layer tuning time of each ONU has elapsed. In addition, an ONU that has completed downstream channel synchronization recognizes the Tuning_Control(Confirm) PLOAM message and PLOAMu grant time which are sent from the target OLT-port, and the ONU responds to the target OLT-port by sending a Tuning_Response(Complete_u) PLOAM in S14a.

As described with reference to FIG. 3, the TC-layer tuning time comprises a time for an ONU to request an optical module for a wavelength change command, a tuning time of an optical module, and a time for the ONU to find again physical synchronization (Psync) information from a changed channel. The PLOAMu grant information and the Tuning_{—} Control(Confirm) PLOAM message are contained in an FS header for each ONU. Thus, as the number of ONUs requested for wavelength tuning increases, an area of FS frame payload shown in FIG. 3 decreases, which may affect, in some cases, downstream service transmission and may require a great amount of time to be allocated for PLOAMu grant and thereby may result in waste of upstream bandwidth for upstream service.

A downstream overhead and an upstream overhead each of which is sent containing PLOAMu grant information and Tuning_Control(Confirm) PLOAM message for each ONU may be calculated as below.

Downstream Overhead=(8-byte Allocation Structure+48-byte Tuning_Control)×the number of ONUs×(T-layer Tuning Time/FS Frame Interval)

Upstream Overhead=(8-byte Allocation Structure)×the number of ONUs×(TC-layer Tuning Time/FS Frame Interval)

In the case of wavelength tuning process shown in FIG. 2 being performed using the downstream FS frame with a format as shown in FIG. 3, as more ONUs are present, both the downstream overhead and the upstream overhead also increase accordingly. For example, if wavelength change is performed for 256 ONUs, time allocated for PLOAMu grant for each ONU increases with the number of ONUs, which causes an increase in the time for completion of wavelength tuning process. This may hinder satisfying requirements for quick and stable services, for example, a service for protection switching within 50 ms.

Hereinafter, wavelength tuning process of an ONU according to an exemplary embodiment will be described. The wavelength tuning process of an ONU as shown in FIG. 2 may apply to the present exemplary embodiment. The differences between the wavelength tuning process of FIG. 2 and the wavelength tuning processing of the present embodiment are: a configuration of Tuning_Control PLOAM message; an operation mechanism of an ONU with respect to the Tuning_Control PLOAM message; a configuration of Tuning_Response PLOAM message; and operation mechanisms of ONU and OLT with respect to the Tuning_Response PLOAM message.

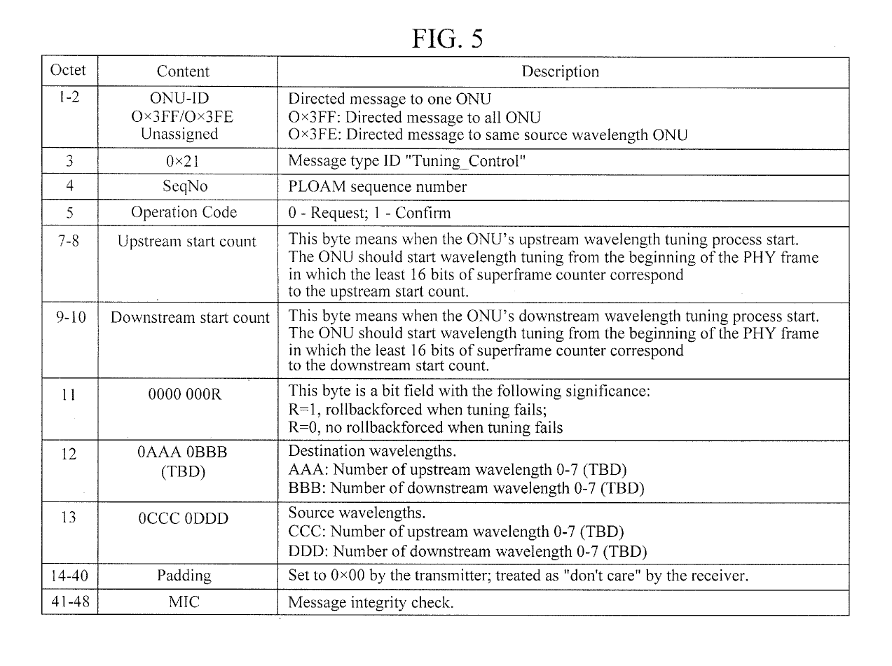

FIG. 5 is a table showing a configuration of Tuning_Control PLOAM message according to an exemplary embodiment. A Tuning_Control PLOAM message is a message that a source OLT-port sends to an ONU in order to request the ONU to change a wavelength channel thereof to a wavelength through which a target OLT-port provides a service or in order to confirm whether or not the ONU has changed the wavelength channel thereof (Refer to S10 and S12 of FIG. 2). Referring to FIG. 5, the Tuning_Control PLOAM message comprises an ONU-ID field (octet 1-2), a message type field (octet 3), a sequence number field (octet 4), an operation code field (octet 5), an upstream start count field (octet 7-8), a downstream start count field (octet 9-10), a rollback field (octet 11), a target wavelength field (octet 12), a source wavelength field (octet 13), a padding field (octet 14-40), and a message integrity check (MIC) field (octet 41-48).

The configuration of Tuning_Control PLOAM message shown in FIG. 5 is different from the configuration of the existing Tuning_Control PLOAM message (refer to draft new recommendation ITU-T G.989.3) in the following points.

First, the existing 2-byte ONU-ID field generally contains a value for identifying or specifying only one ONU, i.e., an individual ONU ID, and the ONU-ID field is a field where to contain ONU identification information to specify an ONU that is a target of wavelength tuning. Whereas, in the present exemplary embodiment, an ONU-ID field contains a system ONU ID and/or an ID for ONUs using the same channel (hereinafter, referred to as a “channel ONU ID”), wherein the system ONU ID is a value to specify all ONUs (hereinafter, referred to as “system ONUs”) that are provided with services through a TWDM-PON system and the channel ONU ID is a value to specify all ONUs (hereinafter, referred to as “the channel ONUs) that are provided with services through the same channel. In FIG. 5, a value to indicate the system ONUs is “0x3FF” and a value to indicate the channel ONUs is “0x3FE”.

Second, the existing 1-byte operation code field contains a request mode, whereas, in the present exemplary embodiment, a 1-byte operation code contains a confirm mode as well as a request mode. The confirm mode may be used to check whether or not the ONU has completed wavelength tuning process in response to a request for wavelength channel change that is contained in the previous Tuning_Control PLOAM message of a request mode (refer to S12 in FIG. 2).

Finally, the Tuning_Control PLOAM message generally does not include a source wavelength field, whereas in the present exemplary embodiment, a Tuning_Control PLOAM message contains a source wavelength field. In FIG. 5, 1-byte source wavelength field is illustrated as being contained as the 13^{th} octet of the Tuning_Control PLOAM, but this is only exemplary. The source wavelength field is to provide information on each of downstream channel and upstream channel of a source channel. For instance, the lower 3 bits [2:0] of the source wavelength field may be used to represent a value for an upstream channel, and the upper 3 bits [6:4] may be used to represent a value for a downstream channel.

Part of (S10 and S11 of FIG. 2) of the wavelength tuning process using the new Tuning_Control PLOAM message with the aforementioned configuration may proceed as follows:

1. When receiving a Tuning_Control(Request) PLOAM message that contains “0x3FF” in an ONU-ID field, all ONUs that are provided with a service through a particular TWDM-PON system respond to a source OLT-port by sending either a Tuning_Response(ACK) PLOAM message or a Tuning_Response(NACK) PLOAM message according to whether or not they can change a wavelength thereof.

2. When receiving a Tuning_Control(Request) PLOAM message that contains “0x3FE” in an ONU-ID field, all ONUS that are provided with a service from a particular source OLT-port responds to the source OLT-port by sending either a Tuning_Response(ACK) PLOAM message or a Tuning_Response(NACK) PLOAM message according to whether or not they can change a wavelength thereof. In some embodiments, an ONU that has received a Tuning_Control(Request) PLOAM message with “0x3FE” as an ONU-ID may compare its own channel information with source channel information contained in the received message, and only when they match each other, the ONU may respond to the source OLT-port by sending either a Tuning_Response(ACK) PLOAM message or a Tuning_Response(NACK) PLOAM message according to whether or not the ONU can change a wavelength thereof.

3. When receiving a Tuning_Control(Request) PLOAM message that contains an individual ONU-ID value in an ONU-ID field, a particular ONU specified by the ONU-ID value may respond to the source OLT-port by sending either a Tuning_Response(ACK) PLOAM message or a Tuning_Response(NACK) PLOAM message according to whether or not the ONU can change a wavelength thereof.

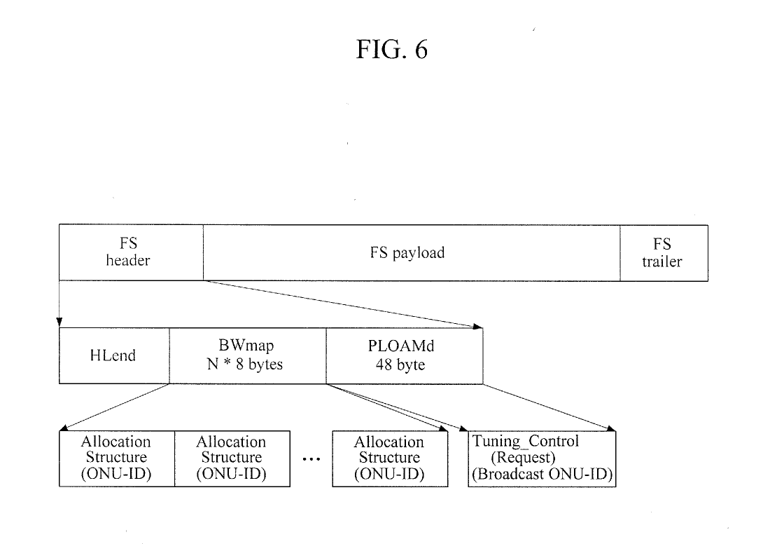

FIG. 6 is a diagram illustrating an example of a downstream FS frame format according to an exemplary embodiment when an ONU-ID field of Tuning_Control PLOAM message as shown in FIG. 5 contains a value that indicates system ONUs or the channel ONUs. Referring to FIG. 6, similarly to the existing frame format (refer to FIG. 3), the downstream FS frame according to the exemplary embodiment consists of an FS header, an FS payload, and an FS trailer, wherein the FS header consists of HLend structure of a fixed size and two partitions of variable sizes, i.e., a bandwidth map (“BWmap”) field and a downstream PLOAM (“PLOAMd”) field.

However, in the case of requesting the system ONUs or the channel ONUs for wavelength change, the downstream FS frame according to the present embodiment may have as many allocation structures in the BWmap field as the number of ONUs that are requested for wavelength tuning while having a single Tuning_Control PLOAM message in the PLOAMd field. That is, even in the case where a plurality of ONUs are requested for wavelength tuning, the PLOAMd field contains only one 48-byte Tuning_Control PLOAM message. In this case, the single Tuning_Control PLOAM message contains, as an ONU-ID, a value (represented s Broadcast ONU-ID in FIG. 6) that indicates system ONUs or a value that indicates the channel ONUs, wherein the ONU-ID is information for specifying ONUs that are targets of the downstream FS frame. Accordingly, when, for example, a total of 256 ONUs are requested for wavelength tuning, the FS frame header uses only 2,030 bytes, which results in an about 85 percent reduction in overhead as compared to the existing frame header as described with reference to FIG. 3.

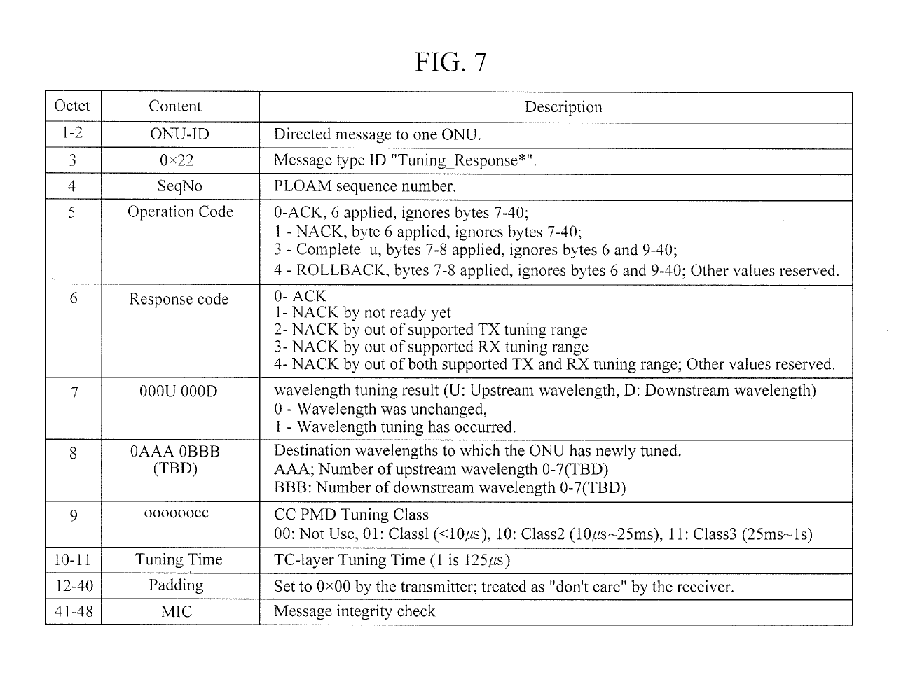

FIG. 7 is a table showing a configuration of a Tuning_Response PLOAM message according to an exemplary embodiment. A Tuning_Response PLOAM message is a message that an ONU sends to a source OLT-port or a target OLT-port in response to a received Tuning_Control PLOAM message (refer to S11 and S14 of FIG. 2). Referring to FIG. 7, the Tuning_Response PLOAM message comprises an ONU-ID field (octet 1-2), a message type field (octet 3), a sequence number field (octet 4), an operation code field (octet 5), a response code field (octet 6), a wavelength tuning result field (octet 7), a destination wavelength field (octet 8), a tuning class field (octet 9), a tuning time field (octet 10-11), a padding field (octet 24-40), and an MIC field (octet 41-48).

The configuration of Tuning_Response PLOAM message as shown in FIG. 7 is different from the configuration of the existing Tuning_Response PLOAM message (refer to draft new recommendation ITU-T G.989.3) in that it additionally has a tuning class field and a tuning time field. The tuning class field contains PMD tuning class information of an ONU. The PMD tuning class information may be represented by using a given number of bits, depending on an amount of time or time range that is spent on tuning, and it may be represented by 2 bits. FIG. 7 shows an example of 2-bit representation of PMD tuning class information. The tuning time field may contain TC-layer tuning time information of the ONU. For example, the TC-layer tuning time information may be indicated by a 2-byte value that is counted in units of 125 μs. The PMD tuning class information of the ONU and the TC-layer tuning time information may be used individually or altogether to indicate a wavelength tuning time of the ONU.

In the present exemplary embodiment, the source OLT-port that has received the Tuning_Response PLOAM message as shown in FIG. 7 from the ONU needs to forward the received message or information contained in the message to a target OLT-port. The forwarded message or information allows the target OLT-port to send PLOAMu grant information and a Tuning_Control(Confirm) PLOAM message at the same interval as the source OLT-port. In addition, part (S11 and S12 of FIG. 2) of the wavelength tuning process using the new Tuning_Response PLOAM message with the above configuration may proceed as follows.

1. When receiving a Tuning_Response(ACK) PLOAM message with “01” (referring to FIG. 7, this value indicates that the corresponding ONU is in class 1 and a tuning time of the ONU is smaller than 10 μs) in a tuning class field thereof in S11, a source OLT-port and/or a target OLT-port periodically sends PLOAMu grant and a Tuning_Control PLOAM message to the ONU at intervals of 125 μs in S12.

2. When receiving a Tuning_Response(ACK) PLOAM message with “10” (referring to FIG. 7, this value indicates that the corresponding ONU is in class 2 and a tuning time of the ONU ranges from 10 μs to 25 μs) in a tuning class field thereof in S11, a source OLT-port and/or a target OLT-port periodically sends PLOAMu grant and a Tuning_Control PLOAM message to the ONU at specific intervals, ranging from 125 μs to 2 ms in S12.

3. When receiving a Tuning_Response(ACK) PLOAM message with “11” (referring to FIG. 7, this value indicates that the corresponding GNU is in class 3 and a tuning time of the ONU ranges from 25 μs to 1 ms) in a tuning class field thereof in S11, a source OLT-port and/or a target OLT-port periodically sends PLOAMu grant and a Tuning_Control PLOAM message to the ONU in S12 at specific intervals, ranging from 2 ms to 100 ms.

4. When receiving a Tuning_Response(ACK) PLOAM message with “00” (referring to FIG. 7, this value indicates “Not Use”) in a tuning class field thereof in S11, a source OLT-port and/or a target OLT-port periodically and dynamically sends PLOAMu grant and a Tuning_Control PLOAM message to the ONU in S12. A time interval between the moment of sending PLOAMu grant information and the moment of sending the Tuning_Control PLOAM message may be set by the source OLT-port and/or the target OLT-port based on a value written in a tuning time field. In this case, a value for the tuning time of the ONU may increase by 1 every 125 μs like in the existing method.

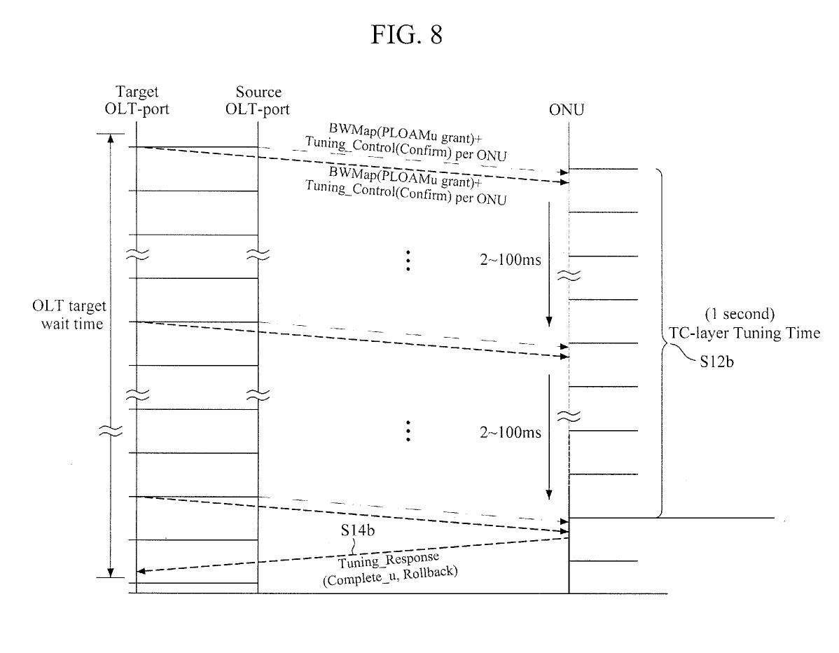

FIG. 8 is a flowchart illustrating in detail operations of an OLT to send PLOAMu grant information and a Tuning_Control(Confirm) PLOAM message according to the exemplary embodiment when the OLT has received a Tuning_Response(ACK) PLOAM message with “11” written in a tuning class field. The flowchart shown in FIG. 8 corresponds to operation S12 and operation S14 in the flowchart of FIG. 2. As described above, the PLOAMu grant information contains information on a time allocated for the ONU's response, in order to confirm whether or not the ONU has completed wavelength tuning process.

Referring to FIG. 8, an ONU that has received a Tuning_Response(ACK) PLOAM message with “11” written in a tuning class field has a TC-layer tuning time of 1 second. In S12b, in response to receiving the information, the source OLT-port and the target OLT-port each periodically send PLOAMu grant information and a Tuning_Control(Confirm) PLOAM message at specific intervals, ranging from 2 ms to 100 ms, until the TC-layer tuning time (1 second) has elapsed. Accordingly, it is possible to efficiently use upstream resources, as well as use less downstream resources, when compared to the existing method whereby each OLT that does not take into account a TC-layer tuning time of an ONU periodically sends PLOAMu grant information and a Tuning_Control(Confirm) PLOAM message at intervals of 125 μs. In S14b, the ONU that has completed downstream channel synchronization recognizes a Tuning_Control(Confirm) PLOAM message and a PLOAMu grant time that have sent from the target OLT-port, and responds to the target OLT-port by sending a Tuning_Response(Complete_u) PLOAM message.

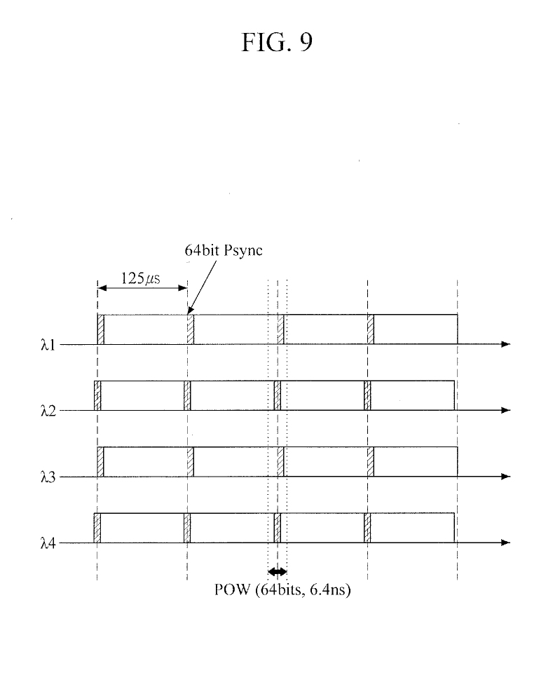

FIG. 9 is a graph explaining physical synchronization (Psync) restoration process that is applicable to the wavelength tuning process according to the exemplary embodiment. As described above, an ONU needs to complete TC-layer tuning in order to receive the PLOAMu grant information and the Tuning_Control(Confirm) PLOAM message from the target OLT. The TC-layer tuning process of ONU includes physical synchronization restoration, as well as PMD tuning. The physical synchronization restoration of ONU is performed to find 64-bit Psync information. According to the existing method, i.e., a method described by the current draft new recommendation ITU-T G.989.3, at least 250 μs are taken to find Psync information. Accordingly, even if only several tens of μs are taken for PMD tuning, the entire time taken for TC-layer tuning process will be several hundreds of μs at the minimum. Whereas according to the exemplary embodiment illustrated in FIG. 5, a physical synchronization of window (POW) section which does not exceed 64 bits is set, and the physical synchronization restoration process allows 64-bit Psync information to be detected within this POW period. This process is carried out based on the fact that the times of sending the Psync information are almost the same among channels λ1, λ2, λ3, and λ4, whereby the 64-bit Psync information can be more quickly detected from the POW within 64 bits. According to the exemplary embodiments, the time taken to perform physical synchronization restoration process can be reduced by a minimum of 250 μs, and up to 6.4 ns, when compared to the existing process.

According to the above exemplary embodiments, it is possible to efficiently and quickly perform wavelength tuning of a plurality of ONUs that are provided with a service in a TWDM-PON system and/or a plurality of ONUs that are provided with a service through a particular channel. In addition, wavelength tuning performance of ONUs, for example, transmission time allocation for an upstream signal may be dynamically adjusted based on the time actually taken to perform wavelength tuning. Accordingly, it is possible to noticeably reduce overhead which affects an OLT when wavelength tuning of a plurality of ONUs, such as system ONUs or the channel ONUs is performed, as well as to ensure service quality of a link protection switching service, and achieve effective power saving.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of tuning a wavelength of a tunable optical network unit (ONU) in a time and wavelength division multiplexing-passive optical network (TWDM-PON), the method comprising:
transmitting a wavelength change request message from a source optical line terminal (OLT) to request the ONU to change a wavelength thereof from a first wavelength through which the source OLT provides a service to the ONU to a second wavelength through which a target OLT provides a service; and
in response to the wavelength change request message, transmitting a wavelength change response message from the ONU to the source OLT to indicate whether or not the ONU can change a wavelength thereof,
wherein the wavelength change request message contains one of the following: a system ONU identification (ID), a channel ONU ID, and individual ONU ID, as identification information for specifying an ONU that is requested to change a wavelength thereof.

2. The method of claim 1, wherein the wavelength change request message is a Tuning_Control PLOAM message, the wavelength change response message is a Tuning_{—} Response PLOAM message, and the identification information is contained in an ONU-ID field of the Tuning_Control PLOAM message.

3. The method of claim 2, wherein the Tuning_Control PLOAM message comprises a target wavelength field that contains information on the second wavelength and a source wavelength field that contains information on the first wavelength.

4. The method of claim 3, wherein the ONU compares its own wavelength information with wavelength information contained in the source wavelength field and, only when both information match each other, transmits the Tuning_Response PLOAM message.

5. The method of claim 1, further comprising:
periodically transmitting a wavelength change confirm message and upstream time allocation information from the source OLT and the target OLT in response to receiving the wavelength change response message,
wherein the wavelength change response message contains wavelength tuning time information of the ONU, and the source OLT and the target OLT adaptively determine a time interval at which to transmit the wavelength change confirm message and the upstream time allocation information based on the wavelength tuning time information.

6. The method of claim 5, wherein the wavelength change request message is a Tuning_Control PLOAM message and the wavelength change response message is a Tuning_Response PLOAM message,
wherein the wavelength tuning time information comprises either or both of physical media dependence (PMD) tuning class information and transmission convergence (TC)-layer tuning time information, which are contained in the Tuning_Control PLOAM message.

7. The method of claim 6, wherein the PMD tuning class information is represented by 2 bits to indicate a time taken to perform wavelength tuning of the ONU.

8. The method of claim 7, wherein:
when the PMD tuning class information is set to “01”, the source OLT and the target OLT each transmit both the wavelength change confirm message and the upstream time allocation information at intervals of 125 μs,
when the PMD tuning class information is set to “10”, the source OLT and the target OLT each transmit both the wavelength change confirm message and the upstream time allocation information at specific intervals, ranging from 125 μs to 2 ms,
when the PMD tuning class information is set to “11”, the source OLT and the target OLT each transmit both the wavelength change confirm message and the upstream time allocation information at specific intervals, ranging from 2 ms to 100 ms, and
when the PMD tuning class information is set to “00”, the source OLT and the target OLT each determine the interval at which to transmit both the wavelength change confirm message and the upstream time allocation information based on the TC-layer tuning time information.

9. The method of claim 6, wherein the TC-layer tuning time information is represented by a 2-byte value that is counted in units of 125 μs.

10. The method of claim 5, further comprising:
receiving, at the ONU, the wavelength change confirm message and the upstream time allocation information from the target OLT,
wherein the ONU detects a physical synchronization signal of the second wavelength within a physical synchronization of window (POW) having a predetermined range based on a location of a physical synchronization signal of the first wavelength.

11. The method of claim 10, wherein the physical synchronization of window has a range of 64 bits.

12. A method of tuning a wavelength of a tunable ONU in a TWDM-PON, the method comprising:
transmitting a wavelength change request message from a source OLT to request the ONU to change a wavelength thereof from a first wavelength through which the source OLT provides a service to the ONU to a second wavelength through which a target OLT provides a service;
in response to the wavelength change request message, transmitting a wavelength change response message from the ONU to the source OLT to indicate whether or not the ONU can change a wavelength thereof; and
in response to receiving the wavelength change response message, periodically transmitting a wavelength change confirm message and upstream time allocation information from the source OLT and the target OLT,
wherein the wavelength change response message contains wavelength tuning time information of the ONU, and the source OLT and the target OLRT each adaptively determine their intervals at which to transmit the wavelength change confirm message and the upstream time allocation information based on the wavelength tuning time information.
